(19) United States
(12) Patent Application Publication
(10) Pub. No.: US 2011/0082880 A1
(43) Pub. Date: Apr. 7, 2011

(54) SYSTEM FOR AND METHOD OF SEARCHING CONTENT

(75) Inventors: Venkata S. ADIMATYAM, Irving, TX (US); Sameer GAVADE, Irving, TX (US)

(73) Assignee: VERIZON PATENT AND LICENSING, INC., Basking Ridge, NJ (US)

(21) Appl. No.: 12/575,200

(22) Filed: Oct. 7, 2009

(51) Int. Cl. G06F 17/30

(52) U.S. Cl. 707/770; 707/E17.014

(57) ABSTRACT

A system for and method of searching content is presented. The system and method allow a user to search within content stored locally or on a network by associated closed captioning content, to display the search results, and to play content associated with the search results.

### BACKGROUND INFORMATION

A home entertainment system may include a digital video recorder or other recoding device used to record and replay received content. The content is typically stored and displayed for later replay by title and/or date. Content held remotely in a video on demand server may also only be searchable by title, or may not be searchable at all. A consumer may not remember a title, but may remember other information related to the content. The consumer, however, would still need to review all of the titles, or even sample the content, until the appropriate content is located.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system according to a particular embodiment;

FIG. 2 is a block diagram of a hardware component of the system of a particular embodiment;

FIG. 3 illustrates the appearance of a user interface for a search query according to a particular embodiment;

FIG. 4 is a flowchart illustrating the recording functionality of a particular embodiment;

FIG. 5 is a flowchart illustrating the search and results display functionality of a particular embodiment;

FIG. 6 illustrates the appearance of a search result of a particular embodiment;

FIG. 7 is a flowchart illustrating the trigger search functionality of a particular embodiment; and

FIG. 8 illustrates the appearance of a trigger search result of a particular embodiment.

### DETAILED DESCRIPTION OF PREFERRED EMBODIMENTS

Content, for example and without limitation, may encompass audio and/or video content, or any other content distributed via a network. For example, content may include video and audio content as embodied in a television program or a movie. Content may also include, for example, other types of data that may be transmitted from a content server to a consumer interface via a network. Closed captioning information may include text associated with the content. For example, and without limitation, closed captioning information may include text associated with the audio and/or video of content. Closed captioning may encompass, for example, written text associated with spoken words or other audible signals that are associated with a video program.

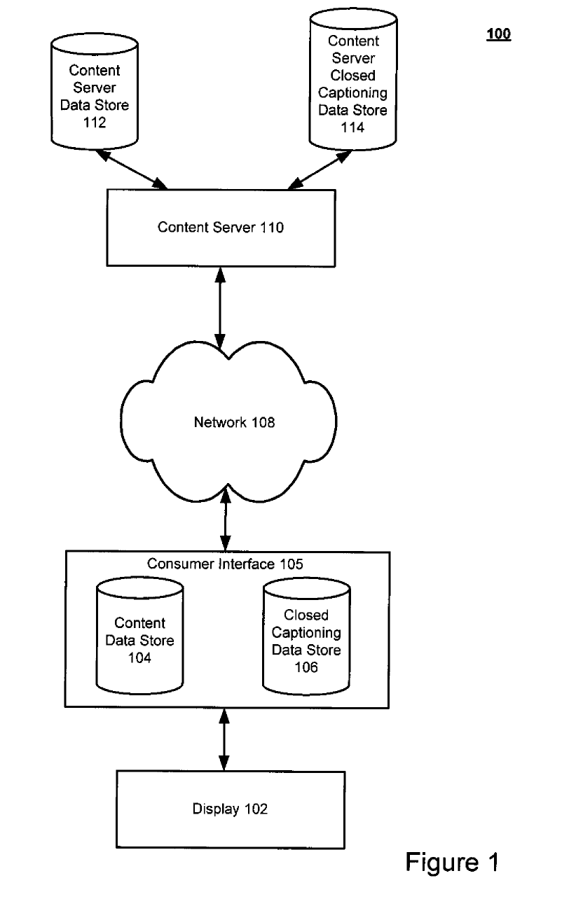

FIG. 1 is a schematic diagram illustrating a system according to a particular embodiment. Display 102 may be a device used to interact with the consumer interface 105 and to view content. Display 102 may be, for example, a standard television set, a monitor without a tuner, or a computer system interfacing with the consumer interface 105. Display 102 may interact with the consumer interface 105 by sending signals to the consumer interface 105 and/or receiving signals from the consumer interface 105. For example, the consumer interface 105 may send signals to the display 102 so that the display 102 may provide video and/or audio content. Display 102 may also interact with other components. For example, and without limitation, display 102 may interact directly with the network 108.

Consumer interface 105 may interact with the display 102, to enable the display 102 to provide content. In an embodiment, the consumer interface 105 may be a set top box that may interface with one or more televisions. The consumer interface 105 may comprise a content data store 104 and a closed captioning data store 106. The consumer interface 105 may be, for example and without limitation, a programmable computer operable to receive signals from the network 108, to transmit signals to the network 108, to receive signals from the display 102, and/or to send signals to the display 102. For example, the consumer interface 105 may receive video and/or audio content and closed captioning content from the content server 110 via the network 108, and may record the video and/or audio content in the content data store 104, and may record the closed captioning information in the closed captioning data store 106. The consumer interface 105 may be programmable, and may utilize, for example, software running on a programmable microprocessor. The consumer interface 105 may also be implemented in hardware, or a combination of hardware and software may be used to implement the functionality of the consumer interface 105.

The content data store 104 may be operable to store data in the form of video and/or audio. For example, the content data store 104 may store data regarding to one or more recorded television programs, or one or more movies, or a combination of television programs and movies. The closed captioning data store 106 may be operable to store data in the form of closed captioning information. For example, and without limitation, the closed captioning data store 106 may store closed captioning information related to the data stored in the content data store 104. In an embodiment, the content data store 104 and the closed captioning data store 106 are maintained as separate databases. In another embodiment, the content data store 104 and the closed captioning data store 106 are maintained as a single database. The content data store 104 and the closed captioning data store 106 may be maintained on separate data storage devices, or may be maintained on the same data storage device. In another embodiment, the content data store 104 and/or the closed captioning data store 106 are maintained on the content server 110, or a system associated with the content server 110, and are not in the same physical location as the consumer interface 105.

Content data store 104 and/or closed captioning data store 106 may be network 108 accessible storage and may be local, remote, or a combination thereof to the consumer interface 105. Content data store 104 and/or closed captioning data store 106 may utilize a redundant array of inexpensive disks (“RAID”), tape, disk, a storage area network 108 (“SAN”), an internet small computer systems interface (“iSCSI”) SAN, a Fibre Channel SAN, a common Internet File System (“CIFS”), network 108 attached storage (“NAS”), a network 108 file system (“NFS”), or other computer accessible storage. In one or more embodiments, the content data store 104 and/or closed captioning data store 106 may be a database, such as an Oracle database, a Microsoft SQL Server database, a DB2 database, a MySQL database, a Sybase database, an object oriented database, a hierarchical database, or other database. The content data store 104 and/or closed captioning data store 106 may utilize flat file structures for storage of data. The content data store 104 and/or closed captioning data store 106 may be different. For example, the content data store 104 and/or closed captioning data store 106 may utilize different file systems, file structures, databases, or hardware.

Network 108 may be a wireless network, a wired network or any combination of wireless network and wired network. For example, network 108 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network 108 (“PAN”), D-AMPS, Wi-Fi, Fixed Wireless Data, IEEE 802.11a, 802.11b, 802.15.1, 802.11n and 802.11g or any other wired or wireless network 108 for transmitting and/or receiving a data signal. In addition, network 108 may include, without limitation, telephone line, fiber optics, IEEE Ethernet 802.3, a wide area network (“WAN”), a local area network (“LAN”), or a global network such as the Internet. Also, network 108 may support, an Internet network, a wireless communication network, a cellular network, or the like, or any combination thereof. Network 108 may be a hybrid fiber-coaxial network, a FTTx system, an IPTV system, or a terrestrial and/or satellite wireless system. Network 108 may further include one, or any number of the exemplary types of networks mentioned above operating as a stand-alone network or in cooperation with each other. Network 108 may utilize one or more protocols of one or more network elements to which it is communicatively coupled. Network 108 may translate to or from other protocols to one or more protocols of network devices. Although network 108 is depicted as one network, it should be appreciated that according to one or more embodiments, network 108 may comprise a plurality of interconnected networks, such as, for example, a service provider network, the Internet, a broadcaster's network, a cable television network, corporate networks, and home networks.

Network elements 102, 105, and 110, and/or data storage areas 104, 106, 112, and 114 may transmit and receive data to and from network 108 representing broadcast content, user request content, parallel search queries, parallel search responses, and other data. The data may be transmitted and received utilizing a standard telecommunications protocol or a standard networking protocol. The data may be transmitted and/or received utilizing other Voice Over IP (“VOIP”) or messaging protocols. For example, data may also be transmitted and/or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving broadcast or parallel search data. Data may be transmitted and received wirelessly or may utilize cabled network or telecom connections such as an Ethernet RJ45/Category 5 Ethernet connection, a fiber connection, a traditional phone wireline connection, a cable connection or other wired network 108 connection. Network 108 may use standard wireless protocols including IEEE 802.11a, 802.11b and 802.11g. Network 108 may also use protocols for a wired connection, such as an IEEE Ethernet 802.3.

Content server 110 or shared content device may be one or more computer systems for the storage and delivery of content. For example, the content server 110 may be operable to store and recall audio, video, and/or closed captioning content. The content server 110 may comprise a content server data store 112 and a content server closed captioning data store 114. The content server 110 may comprise one or more systems, and the systems may be in different geographical locations. For example, one or more content server systems may operate to provide content to a specific region or regions. The content servers may communicate with each other, and each content server 110 may comprise a content server data store 112 and a content server closed captioning data store 114, or the content servers may share one or more common content server data store 112 and content server closed captioning data store 114. The content server 110 may, for example and without limitation, transmit video on demand content to the consumer interface 105. A consumer may, for example, utilize the consumer interface 105 to select video and/or audio content to view. The consumer interface 105 may send a signal to the content server 110 via the network 108 to view the specific content. The content server 110 may request the content server data store 112 to transmit the content to the consumer interface 105 via the network 108, or may transmit the content to the content server 110 for transmission to the consumer interface 105 via the network 108. The consumer interface 105 may also request the closed captioning information for the specific content from the content server 110 closed captioning system, and the content server 110 closed captioning system may transmit the closed captioning information to the consumer interface 105 and/or the content server 110 in a similar manner as the content server data store 112.

The content server data store 112 may be operable to store data in the form of video and/or audio. For example, the content server data store 112 may store data regarding to one or more recorded television programs, or one or more movies, or a combination of television programs and movies. The content server closed captioning data store 114 may be operable to store data in the form of closed captioning information. Closed captioning information may be in ASCII text, for example, or may be in another format for storing, transmitting, and/or receiving text. The closed captioning information may be compressed, or may be encrypted, or may be in clear text. For example, and without limitation, the content server closed captioning data store 114 may store closed captioning information related to the data stored in the content server data store 112. In an embodiment, the content server data store 112 and the content server closed captioning data store 114 are maintained as separate databases. In another embodiment, the content server data store 112 and the content server closed captioning data store 114 are maintained as a single database. The content server data store 112 and the content server closed captioning data store 114 may be maintained on separate data storage devices, or may be maintained on the same data storage device. In another embodiment, the content server data store 112 and/or the content server closed captioning data store 114 are maintained on the content server 110, or a system associated with the content server 110. The content server data store 112 and the content server 110 closed captioning database may be stored on one or more systems associated with the content server 110. For example, and without limitation, the content server data store 112 may be located on one or more systems, where the systems may be in different locations, and may be in a different location than the content server 110. The content server closed captioning data store 114 may also be comprised of one or more physical systems at different geographical locations.

Content server data store 112 and/or content server closed captioning data store 114 may be network 108 accessible storage and may be local, remote, or a combination thereof to the consumer interface 105. Content server data store 112 and/or content server closed captioning data store 114 may utilize a redundant array of inexpensive disks (“RAID”), tape, disk, a storage area network 108 (“SAN”), an internet small computer systems interface (“iSCSI”) SAN, a Fibre Channel SAN, a common Internet File System (“CIFS”), network 108 attached storage (“NAS”), a network 108 file system (“NFS”), or other computer accessible storage. In one or more embodiments, content server data store 112 and/or content server closed captioning data store 114 may be a database, such as an Oracle database, a Microsoft SQL Server database, a DB2 database, a MySQL database, a Sybase database, an object oriented database, a hierarchical database, or other database. The content data store 104 and/or closed captioning data store 106 may utilize flat file structures for storage of data. The content data store 104 and/or closed captioning data store 106 may be different. For example, the content data store 104 and/or closed captioning data store 106 may utilize different file systems, file structures, databases, or hardware.

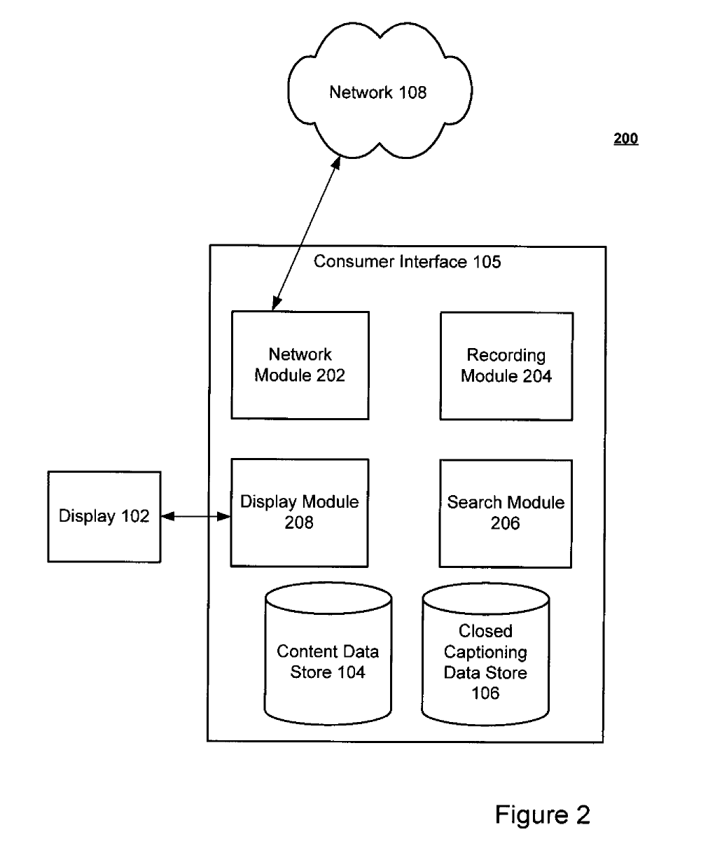

FIG. 2 is a block diagram 200 of a hardware component of the system of a particular embodiment. The consumer interface 105 may comprise one or more modules. The modules may be in communication with each other. The modules may reside on the same physical system, or may reside on more than one physical system, and may be in communication with each other via the network 108 or other connection. The modules may be distinct and may be in communication with each other, or functions of the modules may be embodied in a combination of the modules. The consumer interface 105 may comprise a network module 202, a recording module 204, a search module 206, a display module 208, a content data store 104, and a closed captioning data store 106.

The network module 202 may be in communication with the network 108. The network module 202 may transmit information to other systems via the network 108, and may receive information from other systems via the network 108. The network module 202 may be in communication with the content data store 104, and the closed captioning data store 106 to store and/or retrieve information.

The recording module 204 may be operable to record content that is received by the consumer interface 105. The recording module 204 may be operable to record content received by the consumer interface 105 by, for example, the network 108, the display 102, or another content delivery device that is in communication with the consumer interface 105. For example, a DVD player or a video cassette recorder may be in communication with the consumer interface 105 as external devices, and the recording module 204 may record content communicated from the external devices. The recording module 204 may be in communication with the content data store 104 and/or the closed captioning data store 106, and may record content to the content data store 104. The recording module 204 may also be operable to receive closed captioning information, and may be operable to record the closed captioning information to the closed captioning data store 106. For example, and without limitation, the recording module 204 may receive closed captioning information along with content, or before or after content is received. The recording module 204 may also be operable to create closed captioning content. For example, the recording module 204 may receive video and/or audio content as an input, and apply one or more voice recognition algorithms to the content to create text that is associated with the content.

The display module 208 may be operable to interact with the display 102 to receive signals from the display 102 or to send signals to the display 102. For example, and without limitation, the display module 208 may interface with a display 102 by High-Definition Multimedia Interface (“HDMI”), Digital Video Interface (“DVI”), by coaxial cable, or by other analog interfaces (e.g., RGB connector, antenna cable, or similar interface). The display module 208 may also interface with the display 102 using a unidirectional or bidirectional cable, so that the display module 208 may send signals to the display 102, or may both send and receive signals from the display 102. The display module 208 may be operable to retrieve content from the data store, or from the network 108.

The search module 206 may be operable to search for content in the data store and/or to send a query for content to the content server 110. The search module 206 may interact with the network module 202 to send signals to the content server 110 via the network 108. The search module 206 may also receive a query from a user. For example, the user may enter a search query, and the search module 206 may execute the query and search content stored on the data store. The search module 206 may also transmit a query to the content server 110, so that the content server 110 may search the content server data store 112 and/or the content server closed captioning data store 114 for the search term, and the search module 206 may receive search results from the content server 110. The search module 206 may use the results from the search of the data store and/or the search of the content server 110, and may create search results. The search module 206 may then interact with the display module 208 to display the search results. The search module 206 may search the closed captioning content associated with the closed captioning data store 106, and may send a query to the content server 110 so that the content server 110 may search the content server closed captioning data store 114 for the search terms.

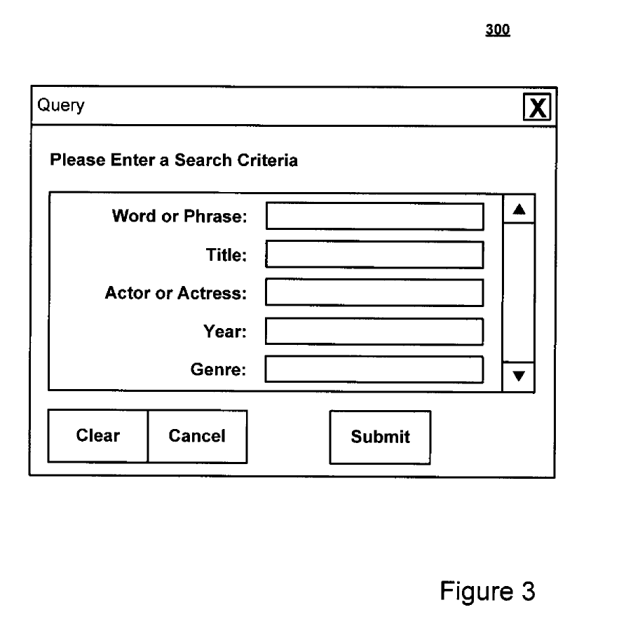

FIG. 3 illustrates the appearance of a user interface for a search query according to a particular embodiment. A user, utilizing a remote control device (not shown) or another device to interface with the consumer interface 105, opens a search dialog 300. The search dialog may include, for example and without limitation, a text box to add a word or phrase or other term that may be found in content, the title of the content, an actor or actress appearing in the content, or other information regarding the content, including the year and the genre. In an embodiment, the user may have the ability to enter any or all of the search terms in a single text box, or may enter the search terms, as shown in FIG. 3, in more than one text box. If the search terms are entered in one text box, the user may use a structured query language to input the search criteria, or may use a free-form criteria to enter one or more criteria into the text box. The dialog box may also include a button to clear the text boxes, and one or more buttons to cancel the search query and close the dialog box. The dialog box may also have a button for the user to press that executes the search criteria found in the one or more text boxes.

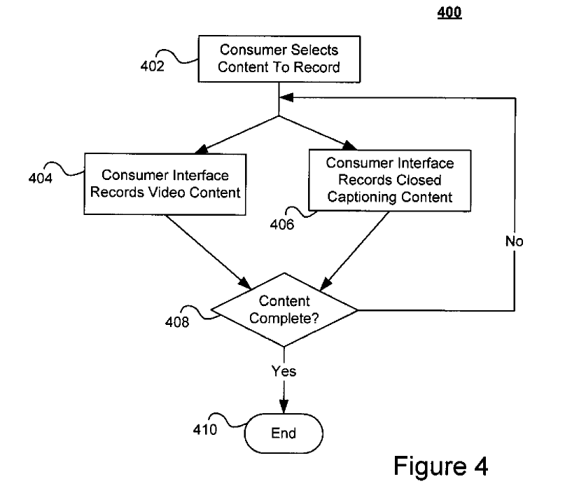

FIG. 4 is a flowchart illustrating the recording functionality of a particular embodiment. The method 400 may begin at step 402 when a consumer selects content to record. The consumer may select content to record by pressing a button on a remote control that is in communication with the consumer interface 105, or may interact with the consumer interface 105 to set one or more rules regarding content to be recorded. For example, the consumer may create a rule with the consumer interface 105 to record all content at 7 PM on Tuesdays, or may create a rule to record all new episodes of a television show, or a movie. When the content to be recorded is received by the consumer interface 105, the consumer interface 105 may record the content and the closed captioning content.

In step 404, the consumer interface 105 may record the content. In step 406, the consumer interface 105 may record the closed captioning content. Both the content and the closed captioning content may be received at the same time, so that the closed captioning content may be displayed in sync with the content. The closed captioning content may be, for example, embedded in the signal for the content, or embodied in a separate signal broadcast concurrently with the content. Or the closed captioning content may be received before or after the content is received.

In step 408, the consumer interface 105 may continue to record the content and the closed captioning content until the content source is complete. For example, if the movie is concluded, the consumer interface 105 may stop recording on the channel of the movie, and the method may end at step 410. If the content is not complete, the method may return to continue to record the content and the closed captioning content, shown in step 404 and step 406.

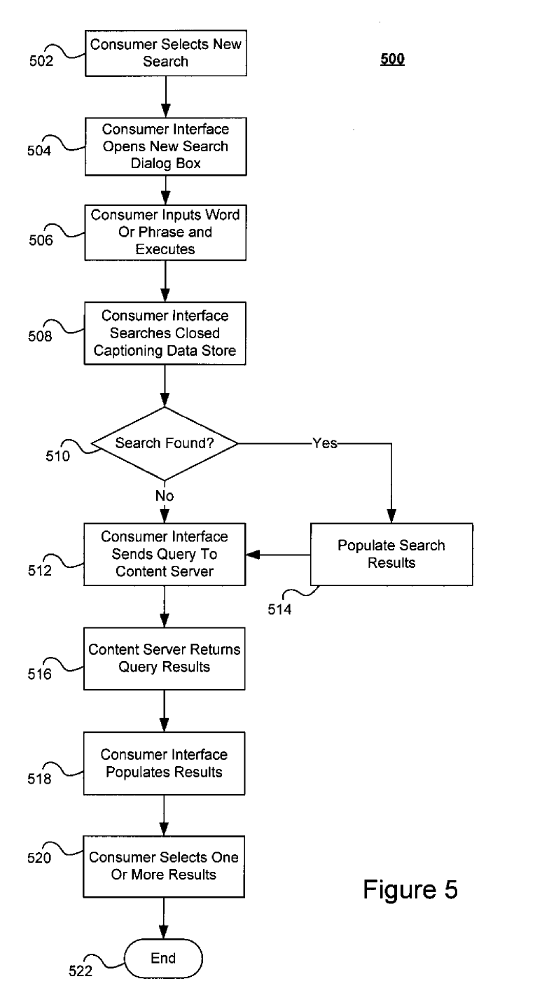

FIG. 5 is a flowchart illustrating the search and results display functionality of a particular embodiment. The method 500 may begin at step 502, where the consumer may select a new search. The consumer may interact with the consumer interface 105 by, for example, pressing one or more buttons on a remote control that is capable of interacting with the consumer interface 105. Or the consumer may interact with the consumer interface 105 by, for example, sending a text message to the consumer interface 105 via a mobile phone, or by interfacing with the consumer interface 105 via a webpage or other connection through a network 108.

In step 504, in response to the request for a new search, the consumer interface 105 may cause a dialog box to display on the display 102. A dialog box as in FIG. 3 may be generated by the consumer interface 105 and may appear on the display 102.

In step 506, the consumer may input a word or phrase into the text search fields of the dialog box and may execute the search. The consumer may input the text into the text box using any method of creating and inputting text. For example, the consumer interface 105 may be operable to receive a text message from a mobile phone or other device, or the remote control interfacing with the consumer interface 105 may include a keyboard, or the remote control may include numerical keypad so that the consumer may input text via the numerical keypad, or the consumer interface 105 may include a touch-sensitive interface with handwriting recognition or a displayed keyboard, or the consumer interface 105 may be in contact with a keyboard or numeric keypad, or the consumer may interact with the consumer interface 105 using a system in communication with the consumer interface 105 over a network 108 or connected directly to the consumer interface 105. The consumer may be able to interface with the consumer interface 105 in order to enter text and to execute the query using the text.

The text search may include, for example and without limitation, a word or phrase that the consumer believes may have been spoken during one or more specific instances of content, or one or more words of the title, one or more names of actors or actresses present in the content, or other information regarding the content. The text search may be a free-form search comprising one or more words, or may be a structured search containing Boolean operators or structured query language, or other arguments.

In step 508, the consumer interface 105 may search the closed captioning data store 106 for the search term. The consumer interface 105 and/or the search module 206 may search the closed captioning data store 106 by, for example and without limitation, executing a query to find full and/or partial matches to the query in the closed captioning data store 106. The search results may be in the form of information regarding the content in the content data store 104. For example, the search results may include one or more pointers to the content referenced in the search results.

In step 510, if search results are found, the search results are included in a list of search results. After the search results list is populated with the search results from the closed captioning data store 106, in step 514, or if no search results are found, the consumer interface 105 may send a query to the content server 110 via the network 108, in step 512. In step 512, the consumer interface 105 may submit a query to the content server 110, or the consumer interface 105 may transmit the text that the consumer entered to the content server 110. The consumer interface 105 may also transmit other information to the content server 110, including, for example, an identification code unique to the consumer interface 105, or the consumer interface's network address.

In step 516, the content server 110 may execute the query received from the consumer interface 105. The content server 110 may also create a new query using the search terms transmitted from the consumer interface 105, and may execute the new query. The content server 110 may search the content server closed captioning data store 114 for a full or partial match of the search terms against the data in the content server closed captioning data store 114. The search results may be in the form of information regarding the content in the content server data store 112. For example, the search results may include one or more pointers to the content referenced in the search results. The content server 110 may receive the search results, if any, from the search of the content server closed captioning data store 114, and may transmit the results to the consumer interface 105.

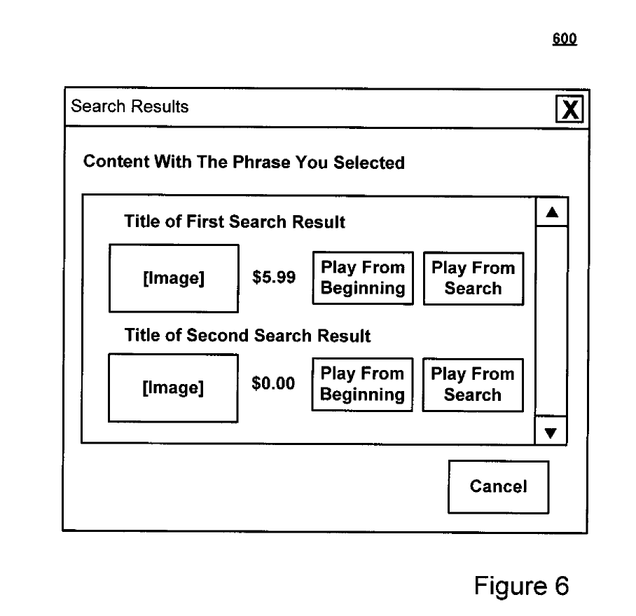

In step 518, the consumer interface 105 may populate a search results dialog box with the search results of the closed captioning data store 106 and of the content server closed captioning data store 114. In one embodiment, the dialog box may be similar to the screen depicted in FIG. 6. The search results may include a list of the titles or other names of the content that contains a full or partial match to the search terms. The search results may be ranked. For example, the search results may be ranked by the number of times the search criteria was used in the content, or may be ranked alphabetically by title, or may be ranked according to type of content (e.g., television content or movie content or other content), or may be ranked according to the location of the content (e.g., the content in the content data store 104 or the content in the content server data store 112), or may be ranked by popularity, or price if the content must be purchased, or may be ranked according to another criteria. The content may also be displayed using a small graphical representation of the content, a “thumbnail” image. The image may be of the content at the time of the first or subsequent use of the search term.

The content may be selectable by the consumer. For example, the consumer may interact with the consumer interface 105 to play the content by pressing a button on a remote interfacing with the consumer interface 105. The consumer may have the ability to play the content from the beginning of the content, or may be able to skip within the content and begin playing the content at the first or subsequent instances of the search terms. For example, if the consumer entered a phrase, and a selection of content was available that included the phrase, the consumer may be able to start the content at or near the first or subsequent use of the phrase in the content.

In step 520, the consumer may select one or more of the search results to play. The selected content is retrieved from the content data store 104 or the content server data store 112 via the content server 110, and is transmitted to the display 102 for viewing. The method may then end at step 522.

FIG. 6 illustrates the appearance of a search result of a particular embodiment. The search result dialog box 600 may include a window with the content with a full or partial match to the search term. Each entry in the search results may include the title of the content, a thumbnail image of the content, the price to view the content, and user selection buttons, including a button to view the selected content from the beginning of the content, a button to view the content from the first or subsequent instance of the search terms, and a button to cancel the search and close the dialog box. The location of the content may also be provided. For example, the content may be stored in the content data store 104 associated with the consumer interface 105, or the content may be stored in the content server data store 112 associated with the content server 110.

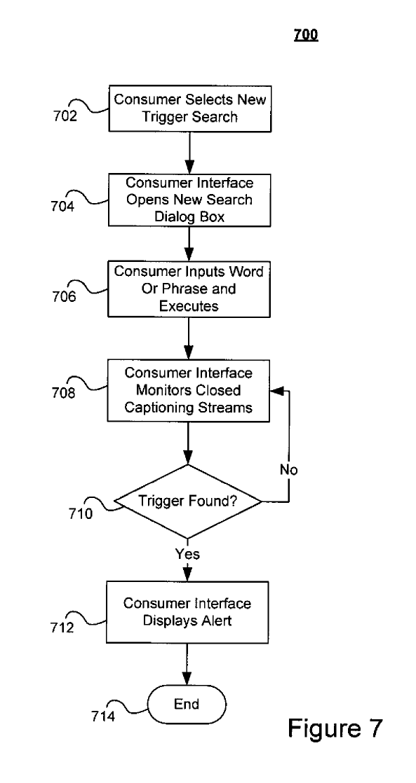

FIG. 7 is a flowchart illustrating the trigger search functionality of a particular embodiment. In an embodiment, the user may set a trigger search term or search terms, and the consumer interface 105 and/or content server 110 may monitor the closed captioning content of one or more channels. If the trigger search term or search terms are found in the closed captioning content, the consumer may be alerted that the search term was found by, for example and without limitation, a pop-up dialog box, if the display 102 is currently displaying another channel. The dialog box may contain selections that allow the consumer to tune to the channel with content matching the search term, or may allow the consumer to record the channel with content matching the search term. The consumer interface 105 may also be operable to automatically record the channel with content matching the search term, without consumer intervention. The amount of time that the channel is recorded may be user-defined. For example, the consumer interface 105 may record the remainder of the television program or movie on the channel, or may record a user-defined number of minutes of the channel, or may record until the content data store 104 is full or is a defined percentage full.

The method 700 may begin at step 702 when a consumer desires to set up a new trigger search. The consumer may create a new trigger search term or trigger search criteria by pressing a button on a remote control that is in communication with the consumer interface 105, or interacting with the consumer interface 105 to set the one or more trigger search criteria in another way.

In step 704, the consumer interface 105 may display a dialog box for a new trigger search criteria. The dialog box may allow the consumer to input a new trigger search criteria, and may allow the consumer to choose one or more channels to monitor for the trigger search criteria. The consumer may choose, for example, to monitor all available channels, or may choose to monitor one channel for the trigger search criteria.

In step 706, the user may input a new trigger search into the consumer interface 105 using, for example, the dialog box. The consumer may input the text into a text box using any method of creating and inputting text. For example, the consumer interface 105 may be operable to receive a text message from a mobile phone or other device, or the remote control interfacing with the consumer interface 105 may include a keyboard, or the remote control may include numerical keypad so that the consumer may input text via the numerical keypad, or the consumer interface 105 may include a touch-sensitive interface with handwriting recognition or a displayed keyboard, or the consumer interface 105 may be in contact with a keyboard or numeric keypad, or the consumer may interact with the consumer interface 105 using a system in communication with the consumer interface 105 over a network 108 or connected directly to the consumer interface 105. The consumer may be able to interface with the consumer interface 105 in order to enter text and to execute the query using the text.

In step 708, the consumer interface 105 may monitor the one or more channels that the consumer has selected for monitoring. The consumer interface 105 may monitor the closed captioning content in real time or in near-real time along with the content. The consumer interface 105 may receive the closed captioning content along with each channel, or may receive the closed captioning content for all available channels separately from the channel. For example, the consumer interface 105 may receive all of the closed captioning content in a separate channel or channels than the channel containing the content.

In step 710, the consumer interface 105 continues to monitor the closed captioning content. If a full and/or partial match is found against the trigger search criteria, then the consumer interface 105 may display an alert, shown in step 712. If the trigger search criteria is not found, the consumer interface 105 may continue to monitor the closed captioning content for the trigger search criteria.

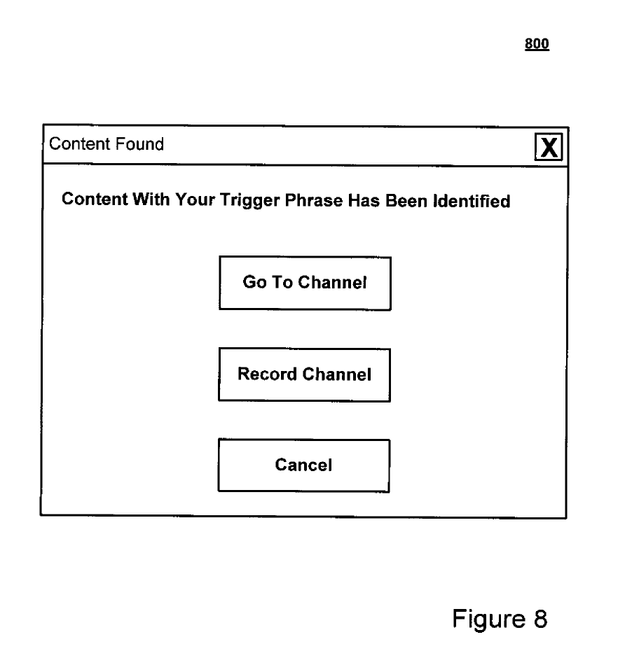

In step 712, the consumer interface 105 may display an alert, an example of which is shown in FIG. 8. In another embodiment, the consumer interface 105 may begin recording the channel with the closed captioning content with a full or partial match to the trigger search criteria. The amount of time the consumer interface 105 records the channel may be pre-selected by the user (e.g., 5 minutes, 10 minutes, etc.), or the consumer interface 105 may record the remainder of the television program, or the consumer interface 105 may record the channel until the content data store 104 is full or is full to a defined percentage (e.g., 90% full, 95% full, etc.). The method may then end at step 714.

FIG. 8 illustrates the appearance of a trigger search result 800 of a particular embodiment. The consumer may be notified that a channel with content matching or partially matching the trigger search criteria was detected by the consumer interface 105. The consumer may be prompted with a dialog box that allows the consumer to either go immediately to the channel, to record the channel so that the consumer could watch the recorded content at a later time, or to cancel and close the dialog box. In another embodiment, the consumer interface 105 may immediately tune to the channel with content matching the trigger search criteria. In another embodiment, the user may define the action when creating the trigger search criteria, and may have different actions for different trigger search criteria. For example, the consumer may define that the consumer interface 105 tune immediately to a channel with content matching one trigger search criteria, and may define that the consumer interface 105 record thirty minutes of a channel with content matching a second trigger search criteria.

It is to be appreciated that the set of instructions, e.g., the software, that configures the computer operating system to perform the operations described above may be contained on any of a wide variety of media or medium, as desired. Further, any data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by a computer.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A method, comprising:
receiving a search request for a term;
electronically searching pre-recorded local storage content located on a local storage for the term;
electronically searching pre-recorded shared content device content located on a shared content device; and
reporting the results of the searches of the local storage and the shared content device.

2. The method of claim 1, wherein the pre-recorded local storage content is searchable by closed captioning content.

3. The method of claim 1, wherein the pre-recorded shared content device content is searchable by closed captioning content.

4. The method of claim 1, wherein the reporting comprises displaying information regarding the pre-recorded local storage content and the pre-recorded shared content device content matching the term.

5. The method of claim 4, further comprising displaying one or more of the pre-recorded local storage content and the pre-recorded shared content device content matching the term.

6. The method of claim 4, further comprising displaying one or more of the pre-recorded local storage content and the pre-recorded shared content device content matching the term, beginning at the location of the term in the pre-recorded local storage content and the pre-recorded shared content device content.

7. The method of claim 1, wherein the pre-recorded local storage content and the pre-recorded shared content device content are each associated with closed captioning content;

8. The method of claim 7, wherein the pre-recorded local storage content closed captioning content is located on the local storage, and the pre-recorded shared content device content closed captioning content is stored on the shared content device.

9. A computer readable media comprising code to perform the acts of the method of claim 1.

10. A system, comprising:
a module for receiving a search request for a term;
a module for electronically searching pre-recorded local storage content located on a local storage for the term;
a module for electronically searching pre-recorded shared content device content located on a shared content device; and
a module for reporting the results of the searches of the local storage and the shared content device.

11. The system of claim 10, wherein the pre-recorded local storage content is searchable by closed captioning content.

12. The system of claim 10, wherein the pre-recorded shared content device content is searchable by closed captioning content.

13. The system of claim 10, wherein the reporting comprises displaying information regarding the pre-recorded local storage content and the pre-recorded shared content device content matching the term.

14. The system of claim 13, further comprising displaying one or more of the pre-recorded local storage content and the pre-recorded shared content device content matching the term.

15. The system of claim 13, further comprising displaying one or more of the pre-recorded local storage content and the pre-recorded shared content device content matching the term, beginning at the location of the term in the pre-recorded local storage content and the pre-recorded shared content device content.

16. The system of claim 10, wherein the pre-recorded local storage content and the pre-recorded shared content device content are each associated with closed captioning content;

17. The method of claim 16, wherein the pre-recorded local storage content closed captioning content is located on the local storage, and the pre-recorded shared content device content closed captioning content is stored on the shared content device.

18. A method, comprising:
providing content located on a shared content device, the content associated with searchable content;
receiving a search request for a term;
searching the searchable content associated with the content for the term;
transmitting information regarding the content search results;
receiving a request to transmit the content associated with the content search results; and
transmitting the content.

19. A method, comprising:
receiving a search term;
monitoring the closed captioning content associated with one or more channels for the search term; and
performing an action if the closed captioning content associated with one or more channels contains the search term.

20. The method of claim 19, wherein the action is to provide an alert to a user.

21. The method of claim 19, wherein the alert is to record the channel on which the search term was found, beginning substantially at the point in time the search term appeared on the channel.

22. A computer readable media comprising code to perform the acts of the method of claim 1.
